(19) United States
(12) Patent Application Publication
(10) Pub. No.: US 2012/0037512 A1
(43) Pub. Date: Feb. 16, 2012

(54) ELECTRODES FOR ELECTROLYSIS OF WATER

(76) Inventor: Maurice James Robertson, Auckland (NZ)

(21) Appl. No.: 13/263,903

(22) PCT Filed: Apr. 15, 2010
(86) PCT No.: PCT/NZ10/00071

§ 371 Date: Oct. 11, 2011

(30) Foreign Application Priority Data
Apr. 17, 2009 (NZ) 572038
Jun. 17, 2009 (NZ) 577730

(51) Int. Cl. C25B 11/04; C25B 11/10; C25B 15/02; C25B 9/02; C25B 11/03; C02F 1/461; C25B 9/06; C25B 11/12

(52) U.S. Cl. 205/759; 204/229.6; 204/290.12; 204/290.15; 204/290.01; 204/286.1; 204/284

(57) ABSTRACT

Electrodes for electrolysis of water, for encouraging growth of algae and aerobic bacteria, for removing suspended solids from wastewater during treatment, or for rendering water sterile and potable have a concrete coating over a metallic or carbon fibre core. The coating is from 2 to 50 mm thick; preferably 5 to 25 mm thick. Preferably, a DC current passed between the immersed electrodes periodically reversed but there is no visible “rusting” at the anode if the DC current is steady. The resistive nature of the concrete tends to suppress concentrations of current upon the electrode surface.

### FIELD

This invention relates to apparatus for electrolysis of water; more particularly to stable and non-toxic electrodes for immersion in a body of water for the purpose of electrolysis of the water.

### DEFINITIONS

Ionic current means a current carried by ions in an ionisable liquid such as a body of water.

An electrode is a conducting body connected to a supply of electricity and immersed in a conducting medium, serving as a source or sink of charged ions in that medium.

Electrochemical disinfection refers to a process of passing an ionic current between electrodes through water in order to sterilise the water.

BOD—biological oxygen demand; used to describe a body of water or part thereof.

HOD (hydrogen-oxidising denitrifying organisms).

V_{CE(SAT)} refers to the inevitable voltage drop across a transistor when saturated (turned fully on). Note that some other solid-state switching devices, or relays, do not exhibit this voltage drop.

### BACKGROUND

There is increasing interest in electrolysis of water for a number of purposes, including:—

(a) sterilisation of bodies of water such as by adding dissolved oxygen or peroxide or halogen oxides. This can be used in waste water treatment, for swimming pools, or to ensure safety of drinking water. Waste water treatment includes storage in tanks or oxidation ponds, optional filtration, and finally release, after adequate quality tests, into the environment, perhaps even as potable water. This is a lengthy process that may require holding vast amounts of water for an extended time. Electrolysis can enhance oxidation, and remove particulates in the final stages. In swimming pools a little sodium chloride or sodium bromide provides the halogen.
(b) adding oxygen to water as a product of electrolysis. Oxygen depletion in the depths of lakes is a well-publicised problem; leading in some cases to death of organisms. Adding oxygen encourages growth of certain types of desired aquatic micro-organisms.

Deaedt et at in Microbiological research 163, (2) 192-199 (2008) describe the disinfection of water containing Legionella pneumophila and Escherischia coli. If actually electrolysed, both types of organism were killed but if a residual concentration of 0.08 mg/l free oxidant was used instead, then the E. coli was killed but the L. pneumoniae was not completely killed.

For the final restoration of waste water as potable water, it is known that a process of electrolysis even in the absence of organisms can help dispose of undesirable contaminants by electrochemical reactions with free, oxygen or hydrogen or chlorine or sodium—the latter being products of electrolysis of sodium chloride. Very small particles are broken apart. It is inefficient to create actual bubbles of gas, because that gas is lost to the microbes. Both hydrogen and oxygen evolved during electrolysis of water may be used in biological processes by micro-organisms in the decomposition of organic waste matter, resulting in treated water with lower values of BOD, TSS, TN (total nitrogen), and PC. Hydrogen serves as an electron donor for hydrogen-oxidising denitrifying (HOD) bacteria. These micro-organisms are autotrophic. They require carbon dioxide only as a carbon source, producing nitrogen and water from the nitrate and hydrogen.

H₂+NO₃→H₂+N₂

Removal of nitrates from effluent reduces the potential for eutrophication of lakes and rivers.

Green algae in a pond or tank add oxygen to the water in proportion to the amount of usable light, as a by-product of photosynthesis. At night, when photosynthesis is halted, no oxygen is produced but continuing respiration of algae and bacteria removes oxygen from the water. Oxygen availability can be a limiting factor in ponds. When unicellular life forms such as algae and/or aerobic bacteria are farmed together, often in a symbiotic relationship, such as during remediation of waste water or if being fanned to make cell products such as edible materials or biofuels, enhanced growth has been noted when the water containing the unicellular life forms is subjected to electrolysis. The reasons for this observation seem to go beyond raising the dissolved oxygen. Perhaps the presence of calcium in the water together with an electrical field may encourage the metabolism of aquatic organisms. See Goldsworthy, N D. Effects of Externally Applied Electric Fields on Growth, retrieved in August 2008 from http://www.bio.ic.ac.uk/dresearch/agold/goldsworthy.htm.

Implementation of electrolysis of the types described above requires cheap, long-lasting, non-toxic electrodes. Electrodes having a working electrode surface composed of platinum or other noble metals (iridium, rhodium, rhenium, etc) have a long life when in use in bodies of water. Other advantages of platinum such as a low over-voltage are known in the art of electrochemistry. Boron-doped diamond has been used as an electrode material. In contrast, electrodes of iron or stainless steel, particularly if used as the anode at a higher current density, will suffer attack, exhibit pitting and other forms of erosion, and so forth. Metal ions are released into, the water. Many such ions are toxic to algae, notably copper ions. An iron anode will rust and degrade over time, although small amounts of ferrous iron may enhance algal growth. Iron has been used to combine with phosphate ions (see JP2000051894). Attempts to use carbon electrodes have not been promising. Even electrodes comprised of woven carbon fibre are attacked when used as anodes; turning into a brown slime. Aluminium anodes will readily oxidise and the resulting oxides and hydroxides will dissolve over time, resulting in degradation of the anode. Titanium anodes do not degrade substantially over time, however their cost may be prohibitive.

Concrete is a conductive, insoluble meshwork of fibrous crystals and embedded inert material, formed by the re-crystallisation of a mineral or in particular of a manufactured product following a chemical reaction with water. One such manufactured product is Portland cement (see below). Concrete is widely used for pipes and tanks for water. Concrete foundations containing reinforcing iron have been used as an electrical earth, even in relatively dry ground. This is the “Ufer Ground” system.

Cement or “ordinary Portland cement” is a finely ground form of Portland cement clinker which is a hydraulic material consisting of at least two-thirds by mass of calcium silicates (3CaO.SiO₂ and 2CaO.SiO₂), the remainder consisting of aluminium- and iron-containing clinker phases and other compounds. Cement is used to make concrete by addition of gravel, sand, and water. A mixture of cement, sand and water, in the absence of added gravel, might be called “plaster”, “grout” or “mortar” or “stucco”. For simplicity we shall refer to it as “concrete” in this specification. A reaction between the cement and water produces a rigid solid material which, of relevance in this invention, is inherently porous, somewhat hygroscopic, and conductive. Either Type U or Type V cement types as defined in the US standard “ASTM 0150” may be best suited for the present application.

### PRIOR ART

Published patents include the following:

WO2008/098298 to Iogenyx describes a “half-electrode” in which one electrode, preferably the anode, is buried in soil beside a tank of algae, or the tank wall itself is used as one electrode. The organisms are protected from materials released from the anode. A cathode is immersed in the liquid. This is asymmetrical, does not lend itself to polarity reversal, and either relies on soil conductivity or places the tank wall at some risk of deterioration. For waste water treatment, AU2005201638 uses a large surface area cathode and encourages bacterial growth upon it, using what is said to be an electrostatic voltage. NZ 534551 from the same inventor makes the cathode into a conduit shape and encourages growth within a non-woven felt layer. Likewise, U.S. Pat. No. 7,404,905 Musson describes cathodes used “in electrostatic mode” to attract a mat of algae. For waste water treatment, JP2000051894 uses two iron plate electrodes adapted to trap microorganisms and their polarity is periodically reversed. Denitrification is promoted, and phosphate ions are removed by flocculation with iron ions. For waste water treatment, JP2003071453 uses porous electrodes adapted to trap microorganisms by flocculation and by a container shape. Oxygen is generated at an anode for consumption by aerobic bacteria. Denitrification is promoted at the cathode. For waste water treatment, U.S. Pat. No. 3,562,137 Gehring cleans up the water in a series of electrolysis cells including electrodialysis membranes to separate the electrodes from the water to be purified; the peri-electrode area generating useful amounts of, for example, caustic soda.

U.S. Pat. No. 3,725,236 Johnson uses “exhaustive electrochemical oxidation” to oxidise organic samples and derive a measure of the BOD. That test method could be used on a process scale. U.S. Pat. No. 3,914,164 Clark makes use of electrolytically generated gas bubbles in order to gently mix aquatic life forms while processing waste water, carried out in a “septic tank extender unit”. The reason for doing this includes removing materials likely to clog the soil in a drain field taking waste water from the septic tank. U.S. Pat. No. 3,925,176 Okert uses electrolysis of waste water to produce oxidising agents effective in killing pathogenic bacteria and fungi. U.S. Pat. No. 4,382,866 Johnson uses a reversible 12V 50 A power source to supply current to a cylinder comprising conductive perforated material separated by non-conductive perforated material wound together; connected as a first electrode or second electrode alternately. Waste water is forced radially though the cylinder. No prior art has been identified in which a vulnerable conductive electrode (such as a carbon or an iron anode) is protected by being cloaked in cement.

### OBJECT

An object of this invention is to provide a substantially inert yet conductive electrode as a replacement for conventional metal electrodes for use in electrolysis of water, or at least to provide the public with a useful choice.

### STATEMENT OF INVENTION

In a first broad aspect the invention provides an electrode suitable for use as either an anode or a cathode during an aqueous electrolysis procedure, wherein the electrode has an electrically conductive interior connected to elongated electrical connection means; the interior being completely covered by a rigid, conductive, non-toxic and non-metallic exterior coat such that the non-metallic exterior only is exposed to the aqueous liquid; the electrode not comprising a part of a containing means holding the aqueous liquid.

Preferably the coat is comprised of a concrete material comprised of a settable cement optionally including further materials selected from &range including carbon and manganese dioxide.

Preferably a minimum thickness of the non-metallic exterior coat is at least 2 mm, more preferably at least 5 mm, and may be at least 10 to 50 mm in thickness over any part of the electrically conductive interior; where thicker coverings confer a more even distribution of surface current.

More preferably the non-metallic exterior coat is in the range of 5 to 25 mm in thickness over any part of the electrically conductive interior.

In another aspect the electrically conductive interior of the or each electrode is comprised of a substance selected from a range including iron, steel, stainless steel, aluminium, titanium, and carbon fibres.

In one option the electrode resembles a flat sheet, having an electrically conductive interior substance having a shape selected from the range of rods, tubes, continuous sheets, open meshes, and perforated sheets to which substance an electrical connection is made.

In another option the electrode has an interior electrically conductive material in the form of a mesh or a linear array of carbon fibres, to which an electrical connection is made.

Optionally the flat sheet includes apertures in between elements of the electrically conductive material.

Optionally the electrode is provided with one or more suspending means so that it may be suspended at a working height while at least partially immersed in the aqueous liquid.

In a further option the electrode is provided as a pair of electrodes wherein the pair comprises a first rod-like electrode bearing a cement coating, mounted concentrically within a second tube-like electrode bearing a cement coating on at least the inside surface; the combination serving as a means for performing electrolysis on a liquid held within.

In another broad aspect the invention provides a reversible power supply for an electrolysis device using at least two electrodes each as previously described in this section; the power supply having a facility of reversing the polarity of a direct current supply connected through the elongated electrical connection means to a first set of one or more electrodes serving for the time being as one or more cathodes and to a second set of one or more electrodes serving for the time being as one or more anodes, at a selected rate.

Preferably the selected rate is between 400 Hz to one alternation a month.

More preferably the selected rate is at about 0.5 Hz.

In a related aspect the invention provides a reversible power supply for an electrolysis device using at least two electrodes each as previously described in this section, wherein the least positive voltage applied to any electrode is maintained at a more positive voltage than that of any other conductive material in contact with the aqueous liquid by means of a further elongated electrical connection means connected from the power supply to said other conductive material, so that said other conductive material acquires cathodic protection.

Preferably the power supply includes means capable of maintaining an ionic current density of about 0.1 mA per square centimetre of electrode surface.

Alternatively the power supply includes means capable of maintaining an ionic current density between the electrodes of between 1 mA and 500 mA per cubic metre of aqueous medium.

Alternatively the power supply includes means capable of maintaining a potential gradient between the electrodes of between 1 V and 24 V per metre of aqueous medium.

In a third broad aspect the invention provides a method of using at least one electrode as previously described in this section with a reversible power supply as previously described in this section, the method being applied to promote of growth of aquatic organisms in an aqueous medium, wherein said aquatic organisms include aerobic bacteria and algae.

In a related aspect the invention provides a method for promotion of growth of selected aquatic organisms in an aqueous medium in a container in a waste water treatment facility, so that biological oxidation proceeds more rapidly.

Preferably a current density sufficient to evolve oxygen as dissolved oxygen into the waste water is used, but not sufficient to generate visible bubbles of oxygen at or near the anode, so that the metabolism of aerobic micro-organisms contained Within the waste water is supported.

In a further related aspect the invention provides a method for sterilisation of water in a container in a waste water treatment facility.

In a yet further related aspect the invention provides waste water processing apparatus employing production of oxygen within the waste water by an electrolytic process, wherein the oxygen is made upon the surface of a conductive non-metallic surface serving as an anode electrode.

In yet another related aspect the invention provides a method for promotion of growth of HOD (hydrogen-oxidising denitrifying) organisms by dissolved hydrogen so that the nitrate content of the waste water is reduced.

In an even further aspect the invention provides a method for maintaining the pH of a body of water in a range between 8.5 and 11.0.

### DETAILED DESCRIPTION OF THE INVENTION

The description of the invention to be provided herein is given purely by way of example and is not to be taken in any way as limiting the scope or extent of the invention. Throughout this specification unless the text requires otherwise, the word “comprise” and variations such as “comprising” or “comprises” will be understood to imply the inclusion of a stated integer or step or group of integers or steps but not the exclusion of any other integer or step or group of integers or steps.

### DRAWINGS

FIG. 1: is a diagram of a typical electrode according to the invention.

FIG. 2: shows a transverse section of a typical electrode according to the invention.

FIG. 3: is a top view of a water treatment tank containing two electrodes according to the invention.

FIG. 4: shows a woven material made of carbon fibre wired and ready for inclusion. Within a concrete electrode.

FIG. 5: shows a circuit diagram for switching between electrodes and maintaining fixed equipment at a lightly more negative voltage.

FIG. 6: shows a floating barge or frame holding suspended electrodes in a “dead” body of water.

FIG. 7: is a graph comparing biological oxygen demand in a test tank, as compared to a control tank not including any electrodes, over time.

FIG. 8: is a graph showing increased growth of aquatic organisms in a test tank, as compared to a control tank not including any electrodes.

FIG. 9: shows a cross-section of an open mesh, coated electrode according to the invention.

FIG. 10: shows a cross-section of a concentric pair of electrodes.

FIG. 11: shows apparatus for making potable water.

### DESCRIPTION OF PREFERRED EMBODIMENTS

In summary the specification will describe the preferred composite electrode made of concrete with a conductive inner mass, then illustrate use of this type of electrode with a power supply, preferably a reversible power supply. Two or more of the invention may be used inside man-made containers such as tanks and conduits, or used in natural environments such as in dams, streams and lakes.

### Example 1

### Concrete-Covered Electrodes

See FIGS. 1, 2, 3, 9 and 10. FIG. 1 is a diagram of a typical electrode 100 of this invention. It has an inner core comprised of a conductive material such as a metal mesh 102 having at least one conducting lead 101 brought to the exterior. A non-metallic conductor 102 such as an array or a mesh of carbon fibres may also be used. Optional lugs or handles 104, 105 or other lifting means may be provided so that the electrode can be immersed in a body of water with only the insulated conductor 101 brought out to an external source of electricity. Preferably the lugs or handles will not, even if cracked, expose the inner core to the aqueous medium. The inner core may also have a reinforcing function for the concrete once it has set. The outer coating 103 is made of a porous conductive settable material preferably though not essentially one based on Portland cement which has been described in the Background. Certain kinds of cement make a concrete that is better adapted to tolerate continued exposure to ground water. Concrete is porous and is known to be conductive, especially when wet, and shows a tendency to be hygroscopic. Concrete includes some free cations including sodium and calcium. The calcium, if released, may assist in the growth or metabolism of the micro-organisms.

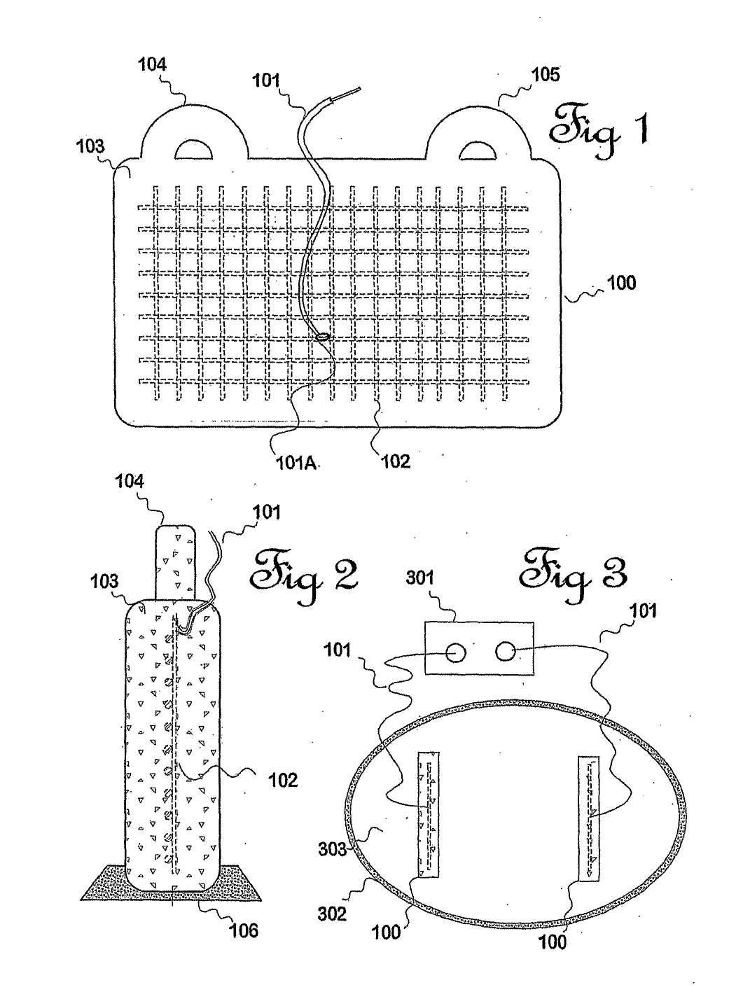

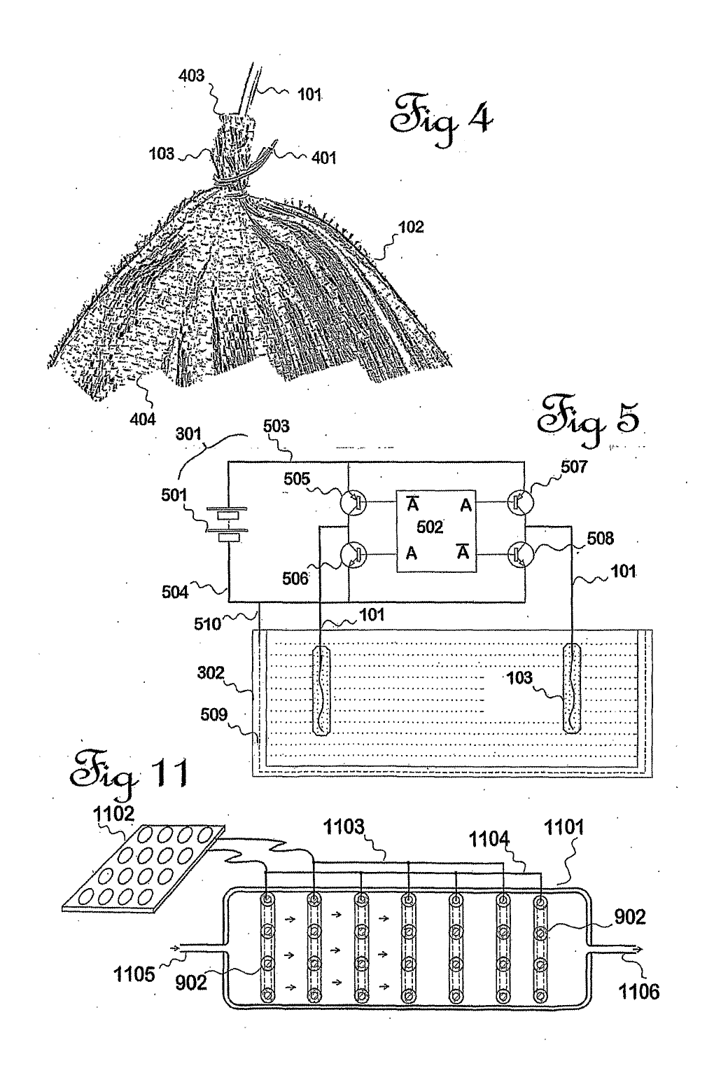

The concrete-covered electrode 100 according to this invention is preferably made with a large surface area to volume ratio so that the resulting current density is nowhere high. The physical form may be a flattened cube. Each electrode may lie horizontally on a tank floor; one above the other, or may be a held vertically, optionally on a base 106, as shown in vertical cross-section in FIG. 2. This cross-section also shows that the inner core is preferably covered to an approximately even thickness with concrete. For example, a minimum coating thickness of 2 min is consistent with the invention; 5 mm may be preferable, and 10-20 rum may offer added strength qualities especially if the underlying conductive material is a relatively flexible carbon fibre mesh. It may be preferable to use 40 or 50 mm of concrete if that will ensure reliability over a service life time. It will be appreciated that a solid slab may be formed by coating a mesh with cement especially in a mould, or an open lattice comprised of mesh elements each of which bears a reasonably even coating may be formed by dipping a steel or carbon fibre mesh into a liquid slurry of cement. An open lattice may assist in flow within a container of a liquid being subject to electrolysis, and will increase the effective surface area of the electrode, FIG. 9 is a cross-section through part of an open-lattice coated electrode. 901 is a sectioned bar of the mesh and 902 indicates an edge of a longitudinal bar, behind the section. 903 indicates an aperture through the electrode. 102 is the central conductor (of metal or carbon fibre), and 103 indicates the cement coating, according to the invention. If the electrodes are not hung from ropes, the base 106 may be placed on the tank floor to support the electrode in a vertical alignment, and with respect to other electrodes (see FIG. 3) placed side by side on a base of a tank as shown in FIG. 3, which is a plan view (from above) of a tank. A power supply 301 is shown. 303 represents the body of water, and 302 represents the wall of the container or tank. Compatible tanks might be made to include an array of grooves that match the electrode dimensions, perhaps down the walls or in the floor, so that the electrodes are held in place. More than one electrode pair may be placed in a tank. Preferably the electrode surfaces face each other, rather than face the walls, so that the tank wall is not included in any significant flow of ions. Preferably the tank wall is involved in current flow as little as possible. It may be non-conductive, or it may be affected if used as an anode.

The electrodes should be installed in a way that allows them to be lifted and their physical condition checked at infrequent intervals such as of six months to one year. It may be convenient to tie polypropylene ropes to the handles 104/105 of each one and leave the ropes trailing outside a manhole cover or retrievable from just inside the cover (if the tank is enclosed), so that electrodes can easily be retrieved. Inspection may be synchronised with tank cleaning operations. It seems inadvisable to lift the electrodes by means of their electric connecting wires 101 since the stress might break the wire or open a crack into the interior. Optionally more than one lead is included in each concrete electrode; in case any one lead breaks or becomes separated from the conductive core. Since a typical current per typical electrode is under 1 A the wire does not need to be heavy Nit it should be insulated.

Slab-like electrodes may be made as follows. A mould of suitable size, like the outline of 100 in FIG. 1 and for example, 42 mm in depth is placed flat upon the ground. First an optional dusting of manganese dioxide powder (to serve as a catalyst for reduction of hydrogen peroxide), or a release agent, or other surface treatment is placed on the bottom of the mould. Then a suitably thick layer of wet concrete is placed over the coating. The wet concrete might include conductive material such as granules of carbon. Then a piece of metal mesh 102, for example “338 reinforcing mesh” which is fabricated from 4 mm diameter mild steel rods spot welded at crossing points at a 50 mm spacing, which already has the insulated conductor 101 bonded to it (such as by brazing and then painting the brazed bead at 101A just in case unwanted copper ions escape into the tank) is placed upon the wet concrete. Then a further layer of wet concrete is poured over the mesh, and the two concrete layers are merged by puddling the wet concrete such as with a rod, so that the concrete layers merge and the mesh becomes sealed within the concrete. Another layer of manganese dioxide or other surface treatment may be dusted over the top surface at the end. A rough external surface gives more surface area than a smooth finish. The electrode can be used once the concrete has hardened sufficiently for the electrode to be removed from the mould and allowed to set further. The above description of manufacture may be modified, as is well known to those skilled in the art, for mass production.

Manufacture of a thin coating over a mesh, according to the invention, may be carried out by dipping the optionally stretched-out conductive mesh into a container of wet cement, or by spraying the wet cement over the mesh, then allowing the cement to set in a moist environment so that the chemical reactions of setting are not prematurely stopped by drying. This approach is likely to result in an open lattice type of construction, as shown in FIG. 9.

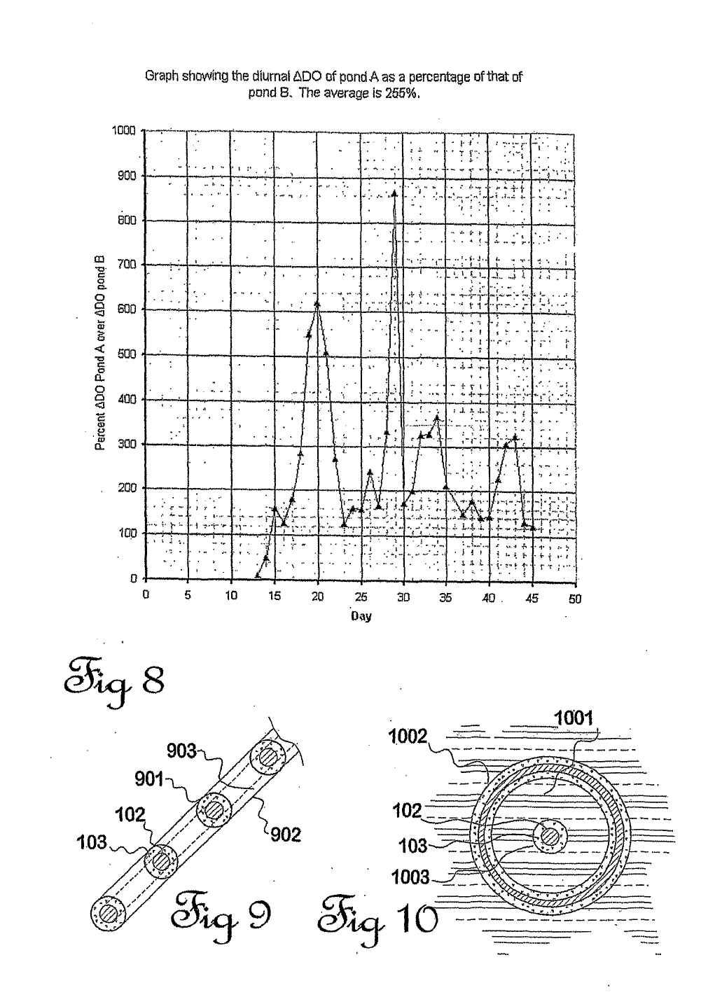

The invention is not limited to planar electrode shapes. FIG. 10 shows a concentric pair of electrodes made according to the invention, wherein the outer electrode 1002 also serves as a pipe and the inner electrode 1003 provides for generation of an ionic current within the interior of the pipe. The inner electrode 1003 is based on a single rod of conductive substance. 1001 indicates water within the pipe, that can be electrolysed. The pipe may be supported within a liquid medium as shown, such as inside a tank as part of a water processing apparatus, or may be used outside a tank as a carrier of water or watery liquid from place to place. 102 is the central conductor (of metal or carbon fibre) of either electrode, and 103 is the cement coating. The outer wall of the pipe 1002 might not have a cement coating if it is used outside a tank. The retention time within the pipe of the water being electrolysed is preferably sufficiently long to allow completion of the required process.

Concrete-coated electrodes according to this invention have been found useful in the production of dissolved hydrogen and dissolved oxygen in a body of water, such as for the benefit of aerobic decomposing micro-organisms which are processing waste water, or for encouraging growth of algae, or for the later stages of rendering waste water re-usable. These are not the only possible applications, however. The outer surface of the concrete, not the conductive core within, serves as the effective electrode surface and the inner core is not degraded—at least much more slowly than an exposed metal or carbon-fibre anode electrode. Meanwhile metal ions do not reach the body of water so potentially cytotoxic or polluting materials do not arise. This approach to the provision of an electrode is a preferred way to overcome the tendency of metal anode surfaces to become oxidised and to then deteriorate and add heavy metals to the issuant waste water.

In this version the effective anode is not a metal. The concrete could be regarded as a form of “half-cell” or “semi-permeable coating”. Operation of this type of electrode over extended periods of months shows no significant deterioration. Migration of metal ions from the core has not been observed. Microbial coverings that may form during use have not as yet been studied; but do not appear to be important in the specific example applications for which the electrodes have been tested. It is important to note that this invention does not describe “electrostatic” processes, because (a) a significant current flow is created and (b) the polarity of the electrodes is preferably interchanged on a regular basis. Any ions arising from the concrete are either non-toxic or beneficial to life, such as calcium, (which also has pH control attributes) or silicon which is a necessary element for algal skeletal structure. Calcium hydroxide usually forms at or within the anode. This compound has the effect of stabilising the pH at a relatively high level within the aquatic environment. At night the calcium hydroxide reacts with the extra carbon dioxide produced by respiration of the aquatic organisms to produce calcium carbonate, which also serves to stabilise the pH of the aquatic environment at relatively high levels. For an aquatic environment that contains aerobic bacteria and/or algae, a preferred pH range is between 7.5 and 12, with an optimum range for wild algae being between 8.5 and 11.0. So long as there are sufficient calcium ions within the aquatic environment, the electrical field will serve to maintain the pH of the aquatic environment within these preferred ranges. Some sodium hydroxide might be added to the wet cement in order to promote the alkalinity.

FIG. 4 shows how a woven sheet 102 made of carbon fibres may be attached to an insulated wire 101. First about 100 mm of insulation is stripped from one end of the wire, exposing the multi-stranded copper wires 401. The wires are laid over an edge of the sheet—preferably midway along one edge, then the sheet is bunched together along its edge (403) and the copper strands are brought away from the sheet and then wrapped around and around the bunch (terminating at 401), so as to form a contact with all of the carbon filaments extending from the bunch towards the far side of the sheet (beyond 404). The exposed copper might optionally be clipped in wax or epoxy or the like, or left alone.

During operation, it has been found that oxidation of the component elements of the concrete at the surface is minimal and that oxygen generated at the anode becomes dissolved in the water, becoming available for microbial respiration and enhancing aerobic decomposition activity. In a trial, four electrodes of the concrete-coated carbon fibre type have been running continuously for 4 months when supplied with a potential difference of 10.5 volts, alternating at an 0.5 Hz rate. The current flow is 50 mA through each electrode. There has been no visible sign of deterioration, nor any change in the current consumption over that time.

Here are details of measurements of a typical carbon-fibre concrete electrode pair immersed in slightly salty pond water. Electrode area, for both sides of one electrode: about 0.2 square metres. A constant supply voltage is maintained between wires 101 of each electrode at 10.5 V. Current passing though loop=75 mA. Voltage drop across each electrode—to its outer surface=2.1 V. Therefore 5.3 volts is dropped across the water. Equivalent electrode resistance=35 ohms each. Equivalent water resistance=70 ohms. Average current density=0.375 A·m⁻². As compared to a simple steel rod used as a cathode, an electrode made of concrete as herein described has a much larger surface area, allowing for greater overall conductivity between two electrodes with water between, thus allowing more ionic current at a fixed voltage. Conductivity tests in pure water in the dark comparing the same amount of metal mesh alone compared with mesh buried within a concrete electrode revealed: Mesh alone: V=10.9 V, I=25.7 mA; Mesh in concrete: V=10.3 V, I=111 mA. Or, if the current was regulated at 18.8 mA, the voltage dropped from around 10V to around 8V when a concrete cathode was substituted for a metal mesh.

The relatively bulky concrete provides a large surface area for the supplied current to pass through so that the current density per unit area is quite low. It is known that algae can be killed if too high a voltage is applied to a cell. This effect may be related to high spot current densities. Another effect relied on in this invention is that the relatively resistive concrete, in series with and between the metal portion of the electrode and the electrolyte, is partially self-regulating. It may, be considered as an infinite number of resistances in parallel that collectively tend to reduce any effect for current density to become concentrated at any one point because a tendency for a higher current to pass through any point leads to a greater voltage drop at that point on account of Ohm's law, and so less current will flow at that point. That is why incorporation of extra conductive materials such as carbon, or steel wool, are not particularly useful, at least in the trials carried out to date. The internal metal structure is used to shorten the conductive path of current through the concrete, so that the series resistance of the concrete does not unduly affect efficiency. This approach to the provision of an electrode is a preferred way to overcome the tendency of metal anode surfaces to become oxidised and to then deteriorate and add heavy metals to the issuant waste water. In this version the effective anode surface is not a metal.

Both anodes and cathode type concrete electrodes are made in the same way, so that the resulting installation is inherently symmetrical and electrode polarity can be reversed from time to time if required—see below. The tank wall and any immersed conductive items such as propellers, pumps or pipes should not be included in any significant flow of ions. Significant ionic current should be restricted to flows between the concrete electrodes. The other parts may be given some cathodic protection by being maintained at a slightly lower voltage than any active concrete electrode (see below). If polarity reversal is not used over a long period of some days, the concrete anode electrode may split open because of accumulation of electrolysis products at the metal/concrete interface. If this does occur, it tends to heal again if that electrode is then used as a cathode for a similar period, by accretion of calcium-rich insoluble salts in the crack.

FIG. 5 shows a preferred reversible power supply 301 including in particular an example switching circuit 301 and a separate connection to the walls of a tank or other immersed conductive items. Since this is a constant-voltage circuit it may easily be connected in parallel to separate tanks or to more than one pair of electrodes 103 in any one tank 302. For example two cathodes are usable with an anode in between—as if seen from an end, view as CAC alternating with ACA, or four electrodes CACA alternating with ACAC, where “C”=cathode and “A”=anode. A 12-volt battery 501 is connected through suitable fuses and a switch (not shown) to a positive bus 503 and a negative bus 504. A mains-drive “plugpack” may be substituted for the battery, or a solar panel, either used alone as a 12-volt panel, or Ma combination with a battery charger and storage batteries for which circuits, are well-known to those skilled in the art. This has the advantage of not requiring that a sewage farm or the like be possibly unsafely wired with mains electricity, and that each tank can be electrically an isolated unit with no stray current flowing through pipes or the tank walls.

Four transistors—where 505 and 507 are PNP types and 506 and 508 are NPN types, are connected across the busses as shown, and the electrodes 103 in the tank 302 are connected to the interconnections between the pairs of transistors. This comprises a standard “H-bridge” switch which, if the transistors are driven in an opposite, complementary way as shown by the “A” and “NOT-A” symbols adjacent their bases by driving means 502 constructed according to standard electronics practice, will connect each electrode alternately to the positive bus then to the negative bus; one out of phase with the other. Driving means 502 should provide symmetrical square wave drives to the transistor bases and preferably at least one binary divider stage is used internally, following an oscillator, to assure symmetry so that there is not a trend for one electrode to be an anode more often than it is a cathode. Because of the inherent V_{CE(SAT)} drops across the transistors the voltage applied to the electrodes is about 10.7 volts. Because of the inherent V_{CE(SAT)} drops across the lower two transistors the cathode electrode at any time is 1×V_{CE(SAT)} above the potential at which the reinforcing 509 of the concrete tank 302 (or any other immersed equipment) is held, so that some cathodic protection is always given. The bonding wire 510 carries about 5 mA in the inventor's experimental prototype. The bonding wire is not essential, but is advantageous for Cathodic protection. In one alternative, such as where conductive tanks placed in conducting soil are present, the bonding wire is connected to an earth peg; a conductor firmly placed within the conducting soil, not to the tanks themselves.

The prototype is preferably run at 0.5 Hz, so that each electrode is alternately held for 1 second as a cathode and then for 1 second as an anode; over time. Other switching devices such as manually operated switches, automatically driven relays, a dual power supply arrangement, or other active solid-state devices may be used. The use described above of the inherent V_{CE(SAT)} drop across a power transistor may be simulated if other switching means are used (such as a relay, a physical switch or connectors, or a different form of solid-state switching device) by including one or more suitably rated silicon or other diode in forward conduction mode between the ground and the least positive contact of each other switching means, as will be apparent to one skilled in the art. This uses the inherent diode voltage drop effect, not dependent on current.

More complex versions may include a microprocessor which may be also attached to monitoring means appropriate for the process in use, optionally also communicating the data to a remote site or storing it for downloading from time to time, and optionally also programmed so as to control taps or valves or other process-control devices so that the process under control is optimised. Daily or weekly alternation could be done manually.

The current density considered to be appropriate for Most purposes is described as “a level slightly under that at which formation of bubbles of dissolved oxygen gas is observed”. That density is about 0.1 milliamperes per square centimetre of anode electrode surface—or about 320 MA for a 0.4×0.4 m two-sided panel shape. Another expression of current density is that it may be set at between 1 mA and 500 mA per cubic metre of water. A constant-current form of DC supply may be used instead of a constant-voltage supply (see Example 3 discussion). Alternatively output from a transducer sampling the dissolved oxygen may be used as input to a voltage or current control means. Water conductivity, reflecting ion concentration, is usually “sufficient” for this invention. Clear water in lakes and rivers typically has specific conductivity of the order of 1000 uS/cm. Waste water typically has higher specific conductivity owing largely to ions in solution, which provides an effective conducting liquid for the electrolysis process. Typical electrochemical reactions during the electrolysis of water are:

### Cathode (Reduction):

4H⁺+4e⁻→2H₂

### Anode (Oxidation):

2H₂O→O₂+4H⁺+4e⁻

The cathode reaction is straight-forward and in water produces hydrogen, which does not react with the cathode material. The hydrogen produced becomes available for HOD bacterial activity (see below), if bacteria are present. Because oxygen is more soluble in water than hydrogen, as current density increase bubbles of hydrogen will occur on the cathode surface before bubbles of oxygen appear at the anode. The anode reaction is more complex and the oxygen produced is readily available to oxidise the material of the anode. If this is a metal, lacking a coating of concrete or the like, the end product is typically a combination of oxides and hydroxides of the metal, which dissolve and contaminate the water.

The solubility of hydrogen in water at 25 deg C. is 1.5 mg/litre of water. Using Faraday's law of electrolysis, 1 mA of current will produce about 0.01 μg of hydrogen per second which will need to move away from the cathode surface before bubbles can form. It has been found that bubbles of hydrogen are produced at the surface of the cathode if there is a current density greater than the order of 1 mA/cm². The solubility of oxygen in water at 25 deg C. is 40 mg/litre. 1 mA will produce about 0.08 μg of oxygen per second which will need to move away from the anode surface to remain dissolved. For a total effective electrode area of 1 m², 1 A will produce a current density of 0.1 mA/cm², which is below the threshold for bubble formation of both hydrogen and oxygen. The amount of oxygen produced over time by 1 A current is about 7 g per day, from Faradays law of electrolysis. In a 1,000 litre pond, assuming no oxygen-consuming organisms or chemicals, this would increase the dissolved oxygen by 7 ppm per day.

### Example 2

### Application in Waste Water

Construction of the preferred concrete electrodes has been described in Example 1. This Example describes a process involving continuous low-level electrolysis for facilitating the secondary or tertiary treatment of wastewater. The experiment was carried out on a waste water system servicing a household of 7 adults. It is believed that the electrolysis acts to treat the water in several ways, including supplementing the dissolved oxygen concentration, and may also provide some gentle stirring.

FIG. 3 is a top view of an active region—a pond in a wastewater plant—wherein two electrodes each labelled 103 are suspended within the tank 302, filled with water to be processed 303. A wire 101 connects between each electrode and a terminal on a preferably alternating power supply 301. The installation may operate in darkness or in light. Here, aerobic micro-organisms are encouraged to proliferate in order to decompose of wastewater, in order to effect a tertiary treatment. Preferably each electrode, if vertically mounted, is high enough to reach from near the upper surface of the wastewater down close to the base.

The operation of the system May be monitored and regulated on a basis including one or more of: (a) measuring the biological oxygen demand of the water, (b) Measuring the coliform content of the outlet water, (c) turbidity or like measurements sensitive to the existence of bubbles in a liquid, around the anode, or (d) a simple ammeter and “rule of thumb” concerning treatment duration. The prototype used a simple DC “plugpack” run from the mains.

A series of tests have been made with a waste water system using electrodes and low-level electrolysis according to the invention as previously described in this document. Samples were taken over a 38 day period with the same waste water system servicing a household of 7 adults. Samples were delivered to NZLabs Ltd, 303 Eastbourne St East, Hastings, NZ, for testing according to approved relevant methods. A time course of results is shown in Table 1 (below).

The operating temperature was in the range of 10 to 20° C. This may be compared with a recent trial of commercial, aerated waste water disposal plants conducted at Rotorua. Of course the above results are not obtained from a “production” system so they can't be compared with that trial which was intended to replicate ordinary operating conditions. The average results obtained from a variety of On-Site Effluent Treatment (OSET) systems in the Rotorua trial, using city sewage give the following average results: Biochemical Oxygen Demand (mg/L)=4.7; Total Suspended Solids (mg/L)=10; Faecal Coliforms (cfu/100 ml)=9.8×10⁴. Only 3 of the 7 systems in the trial showed Total Suspended Solids counts of less than 9 and none came close to the inventor's other figures.

TABLE 1

Date

| | 11 Mar. | 18 Mar. | 2 Apr. | 17 Apr. |
|---|---|---|---|---|
| | 2009 | 2009 | 2009 | 2009 |
| Biochemical | 33 | 31 | 20 | <1 |
| Oxygen | | | | |
| Demand (mg/L) | | | | |
| Total | 78 | 35 | 34 | 9 |
| Suspended | | | | |
| Solids (mg/L) | | | | |
| Faecal | 72,000 | 5,700 | 7,000 | 97 |
| Coliforms | | | | |
| (cfu/100 ml) | | | | |
| Dissolved | 0.47 | 1.9 | 2.9 | 4.5 |
| Oxygen (mg/L) | | | | |

### Example 2A

### Making Potable Water

In many parts of the world, available drinking water in rivers or wells is contaminated and is, in effect, waste water. In order to make such water potable apparatus as shown in FIG. 11 may be used A preferably covered wooden or plastic box or other non-conductive waterproof container 1101, here shown from above, holds a series of open-mesh concrete-coated electrodes 902, each like the electrode 902 in FIG. 9. These are alternately connected to one electrical bus 1103 or another, 1104 as shown, to serve either as an anode and a cathode (example: CACACAC). The buses are supplied from a suitable power supply. For example the stack can be provided with DC power from a solar cell array 1102 and, for simplicity, polarity reversal can be provided manually on perhaps a daily basis by means of a switch, as will be obvious to a reader skilled in the relevant arts. Water fed in at one end 1105 must pass through the holes in the stack of Mesh electrodes, is exposed to ionic currents, and emerges at the other end at 1106 as substantially sterile water. In case life forms, such as parasitic eggs and larvae survive this electrolysis, the emerging water may be filtered. This apparatus has not yet been tested and an appropriate time for exposure of a volume of contaminated water to a known ionic current in order to accomplish sterilisation of specified organisms is not yet known. Use of concrete-coated electrodes will enhance reliability and avoids use of expensive electrode options. The same process may be used to sterilise air conditioning water in order to remove organisms such as Legionella pneumophila, the main cause of Legionnaire's disease.

### Example 3

### Remediation of Anoxic Lakes

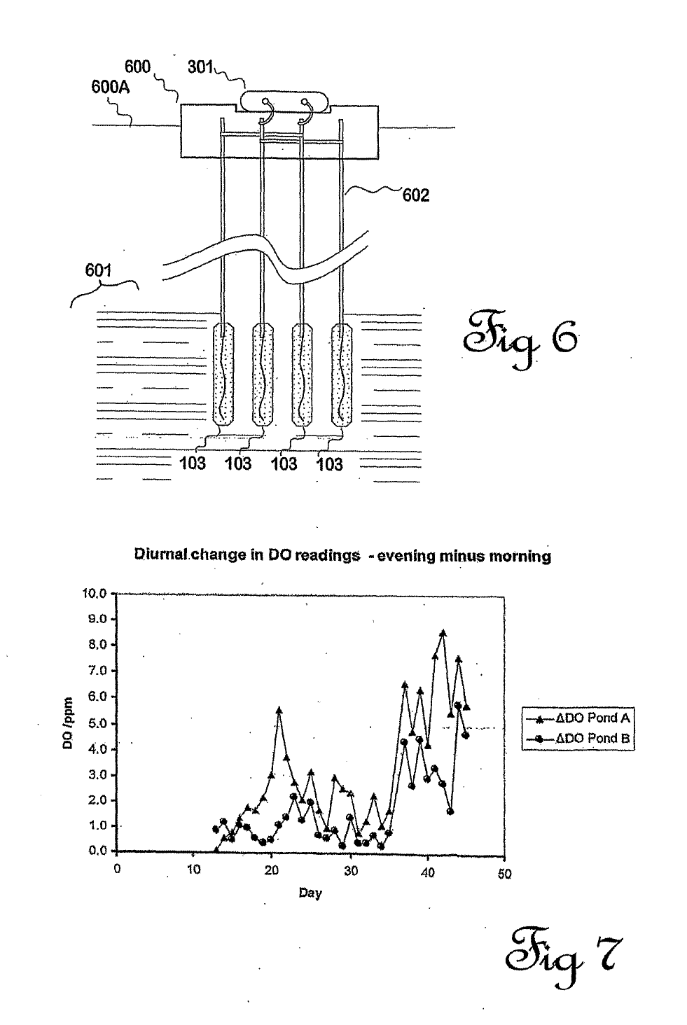

Construction of the preferred concrete electrodes has been described in Example 1. In relation to an as yet un-tested example device for remediation of anoxic lower layers of a lake, FIG. 6 shows a barge 600 or other floating frame preferably moored in place on a lake surface 600A over a deep layer of anoxic water 601. A power supply 301 provides preferably switched DC current to an array of electrodes 103, supported by supports 602. Optionally the power supply is provided With 12V DC from a standard lead-acid battery or the like, and optionally that battery may be continually replenished with electricity from an array of solar cells or the like, for continuous oxygenation. In this diagram we have not shown ropes and conducting leads to the electrodes separately. These may be of considerable length.

When in use, the apparatus is left to run by itself. Since there are no moving parts and me concrete electrodes have been shown to be unaffected by long periods of use, this device may be left in place, which saves on labour costs. It is known that Ultraviolet (UV) sterilisation requires frequent cleaning of the area exposed to UV light. As one option the supply might be run at a higher voltage in order to boost the ionic current density; since the effect of bubbles on mixing of the layers of water may be beneficial. On the other hand, it is dissolved oxygen in particular that counts in this kind of problem, so the doubled voltage may not be any more effective than a supply that does not produce free bubbles. While the act of blowing air under pressure through a pipe into such a layer in order to oxygenate it is well known, this approach to overcoming the problem does not use moving parts and there is no energy required to force a gas downwards, against a head of water. Therefore the example device could be used in quite deep waters, such as in a dammed lake used for a municipal water supply. Further, the theoretical maximum saturation of dissolved oxygen arising from contact with pure oxygen is known; from published articles, to be about 40 ppm (at standard temperature and pressure; STP) or more in a deeper lake, whereas the theoretical maximum saturation of dissolved oxygen arising from contact with air is about 8 ppm.

### Example 4

### Application: Promoting Algal Growth

Construction of the preferred concrete electrodes has been described in Example 1. A pilot study for enhancing the growth of aquatic organisms; for instance of a type which may be used to produce a useful biomass such as for use in animal feeds, human feeds, production of lipid material and the like, or for instance as part of a disposal process, was done in a dual-pond concrete tank, lined with a polythene lining in order to render both ponds separately watertight. Pond A has a 320×320×20 mm concrete-encased anode electrode made using a 300×300 mm section of 338 reinforcing mesh encased in concrete, according to Example 1 and connected to a DC power supply. In this trial it was a DC current-regulated supply. The concrete anode electrode rests on the bottom of the north end of Pond A. In the early part of this DC (non-reversing) Example, a simple cathode electrode which was a 200 mm length of 16 mm diameter steel reinforcing rod, suspended at the south end of Pond A is used. Pond B is the control. It has identical size, shape and treatment, but no electrodes are placed in it, nor is there any other connection to the DC supply. Ponds A and B received identical treatment.

The power supply was set at 11.00 V. The initial current at 1800 h on 1 Sep. 2008 was 7.6 mA. The current was regulated to approximately this value and settled at 8.5 mA, at which current it was regulated up to 1800 h 16 September. The voltage varied diurnally according to aqueous conductivity. The current was then regulated to be 18.8 mA from 1800 h 16 Sep. 2008. The voltage again varied diurnally. A current density a little under that which generates visible bubbles was used. On 20 September, the steel cathode electrode 4 (of FIG. 4) was replaced by another electrode, like the existing anode, consisting of steel mesh encased in concrete. The current was regulated at 18.8 mA, and the voltage dropped from around 10V to around 8V with the concrete cathode, indicating better conductivity of the concrete cathode.

The ponds were placed outdoors in a New Zealand spring season for about 2 months, and their top surfaces were open to the air. The water was inoculated with a supply of aerobic bacteria and algae. Initial treatment was 1.5 litres of a liquid made from horse manure in a barrel of water added to each pond. This served as a supply of aerobic bacteria. A 750 ml stirred sample of fish pond water known to contain species of green algae including Scenedesmus quadricauda was also added. As a result of the electrolysis, providing more oxygen and possibly also providing other benefits to the aquatic organisms including pH control but otherwise beyond the scope of this document, yet without the disadvantages of exposed metal electrodes, growth of the aerobic bacteria and algae is enhanced as shown in FIGS. 7 and 8. FIG. 7 is a graph comparing biological oxygen demand in a test pond “A”, as compared to a control pond “B” not including any electrodes, over 45 days. FIG. 8 is a graph showing increased growth of aquatic organisms in a test pond, as compared to a control pond that did not include any electrodes.

In FIG. 7, the diurnal change in dissolved oxygen readings, presumed to indicate changes in the supply over the consumption of oxygen, is plotted. The treated pond had greater swings in dissolved oxygen.

In FIG. 8, the percentage increase in the daily swing in dissolved oxygen in pond A, as compared to pond B, is plotted as at indication of the biomass present. The inventor did not have means to measure the actual biomass. This method indicates that on average there is 2.55 times as great a biomass in the treated pond as in the pond without electrodes.

A number of factors were not controlled in this pilot study such as the ecological balance of organisms, an accidental spill, and apparent depletion of some raw materials which on one occasion was overcome with application of a plant food (Yates' “Thrive”). The electrode polarities were not reversed at all in this study.

In the preceding examples, the water may be essentially stationary with respect to the electrodes, or it may be caused to move, either by actual bubble formation, by means of an externally caused flow such as through a treatment tank, or by action of pumping means arranged to cause a flow past, or between, or through the electrodes.

### Commercial Advantages

1. The invention provides cheap, long-lasting electrodes for at least relatively low-intensity electrolysis of water.
2. Encasing the electrodes (especially when used as the anode) within concrete protects the metal part of the electrode from degradation.
3. Use of symmetrical anode and cathode electrodes facilitates reversal of electrochemical reactions (simply by reversing polarity) from time to time, at least doubling the life time of the electrodes.
4. Encasing the electrodes in concrete provides a greater surface area for the electrochemical reaction to occur than if mesh alone was used; allowing the current density per unit area to be low.
5. The resistive nature of the concrete allows the surface potential over the concrete surface to be relatively even.
6. Conductivity of the circuit is significantly improved over simple Metal electrodes.
7. Concrete-coated electrodes tend to sink to the bottom of a natural aquatic environment, where the water will generally have less oxygen. Carbon fibre if used on its own is likely to float.
8. The electric field and hence the ionic current flow is substantially horizontal within a tank, for upright electrodes, facilitating a substantially even current density within a tank or the like.
9. The invention enhances the growth of aquatic organisms such as aerobic bacteria and/or algae in a body of water, by increasing the dissolved oxygen content within the aquatic environment using electrical means.
10. Concrete electrodes may release a useful amount of calcium ions into the water, possibly beneficial to the aquatic organisms, or silicon, as silicates or the like by maintaining the pH between optimum pH ranges.
11. The invention increases the rate at which an algal/bacterial process can remediate nutrient-contaminated water, and allows control over that process at a low cost.
12. The invention provides a way to provide potable water in a sustainable manner.
13. A substantial reduction of faecal coliform bacteria per ml is noted. Further tests may be useful since there are likely to be many associated factors.

Finally, it will be understood that the scope of this invention as described by way of example and/or illustrated herein is not limited to the specified embodiments. Where in the foregoing description, reference has been made to specific components or integers of the invention having known equivalents, then such equivalents are included as if individually set forth. Those of skill will appreciate that various modifications, additions, known equivalents, and substitutions are possible without departing from the scope and spirit of the invention as set forth.

1-14. (canceled)

15. Apparatus for the electrolysis of water wherein the apparatus includes (a) at least two electrodes; each electrode having an electrically conductive interior selected from a range of: iron, steel, stainless steel, aluminium, titanium, and carbon fibre and capable of serving alternately as an anode and as a cathode; (b) each electrode having a non-metallic exterior coat having a surface and a controlled thickness; the coat comprising a concrete made using a chemical reaction between Portland cement and water; (c) each electrode also including electrical connection means; (e) the apparatus also including a reversible power supply having at least one first terminal and at least one second terminal capable of being connected in a circuit including the electrodes, (f) the power supply being capable of supplying a current at a controlled current density in a range of between 0.01 milliamperes and 1 milliampere per square centimeter of electrode surface, and (g) the power supply further being capable when in use of regularly reversing the polarity of said current at a rate; thereby allowing any one electrode to serve alternately as a cathode and as an anode.

16. An apparatus as claimed in claim 15, wherein the power supply includes at least one third terminal capable of being electrically connected to any electrically conductive object or objects, not being an electrode, also in contact with the water and the power supply includes means capable of ensuring that the least positive voltage provided to any electrode is maintained at a more positive voltage than the voltage provided at the third terminal, so that said electrically conductive object or objects are provided with cathodic protection.

17. An apparatus as claimed in claim 15, wherein the rate of reversal of the power supply occurs at a selected rate of between 400 Hz to direct current.

18. An apparatus as claimed in claim 17, wherein the selected rate is 0.5 Hz.

19. An electrode for an apparatus as claimed in claim 15, wherein the thickness of the non-metallic exterior coat is in a range of between 2 mm and 50 mm.

20. An electrode as claimed in claim 19, wherein the electrode is provided with one or more suspending means so that, when in use, it may be suspended at a working height while immersed in the water.

21. A pair of electrodes, each as claimed in claim 19, wherein a first rod-like coated electrode is mounted concentrically within a second cylindrical electrode having a coat on at least the inside surface; the combination serving as a means capable of performing electrolysis on water held or carried between the pair of electrodes.

22. An electrode as claimed in claim 19, wherein the electrically conductive interior is provided in the form of an open mesh having apertures passing therethrough, and the exterior coat is sufficiently thin to maintain the presence of said apertures passing therethrough.

23. An apparatus as claimed in claim 15, wherein the apparatus includes a series of at least two open-mesh concrete-coated electrodes wherein for each of the electrodes the electrically conductive interior is provided in the form of an open mesh having apertures passing therethrough, and the exterior coat is sufficiently thin to maintain the presence of said apertures passing therethrough, the thickness of the non-metallic exterior coat being in a range of between 2 mm and 50 mm, the open-mesh concrete-coated electrodes being alternately connected as an anode and a cathode; the series of electrodes being confined in a container such that a flow of water to be treated passes between the meshes of all of the electrodes.

24. A method of use of an apparatus as claimed in claim 15, wherein the method comprises operating the apparatus so as to cause promotion of growth of aquatic organisms selected from a range including aerobic bacteria and algae in an aqueous medium.

25. A method of use of an apparatus as claimed in claim 15, wherein the method comprises operating the apparatus so as to cause sterilisation of water in a container in a waste water treatment facility.

26. A method of use of an apparatus as claimed in claim 15, wherein the method comprises operating the apparatus so as to cause promotion of growth of hydrogen-oxidising denitrifying organisms by dissolved hydrogen so that a nitrate content of the water is reduced.
